(19) United States
(12) Patent Application Publication
(10) Pub. No.: US 2026/0217484 A1
(43) Pub. Date: Jul. 30, 2026

(54) DEVICE AND METHOD FOR EMPTYING A CONTAINER WITH A LINER

(71) Applicant: EMDE Automation GmbH, Nassau (DE)

(72) Inventor: Joerg SCHOLZ, Gackenbach (DE)

(73) Assignee: EMDE Automation GmbH, Nassau (DE)

(21) Appl. No.: 19/630,020

(22) Filed: Mar. 26, 2026

Related U.S. Application Data
(63) Continuation of application No. PCT/EP2024/076803, filed on Sep. 24, 2024.

(30) Foreign Application Priority Data
Sep. 26, 2023 (DE) 10 2023 126 090.1

(51) Int. Cl. B65G 65/34; B65G 69/18

(52) U.S. Cl. CPC B65G 65/34; B65G 69/181

(57) ABSTRACT

A device and a method for emptying a container with a liner. A product guide tube with an upper liner connection end, a lower connection end, and an access socket branch off from the product guide tube and is capable of being closed. The liner connection end comprises a sealing ring arrangement, which has an outer ring arrangement fixedly connected to the product guide tube and a guide ring arrangement formed coaxially to the outer ring arrangement and axially adjustable along a tube axis. The outer ring arrangement has on its inner side, a lower and an upper radially inwardly adjustable sealing ring, which are spaced apart from one another in the axial direction along the tube axis. The guide ring arrangement comprises a guide socket with an outer sealing surface which are arranged in a working position of the guide ring arrangement radially inside the sealing rings.

This nonprovisional application is a continuation of International Application No. PCT/EP2024/076803, which was filed on September 24, 2024, and which claims priority to German Patent Application No. 10 2023 126 090.1, which was filed in Germany on September 26, 2023, and which are both herein incorporated by reference.

### BACKGROUND OF THE INVENTION

### Field of the Invention

The present disclosure relates generally, and in particular, to a device and a method for emptying a container having a liner – a flexible inner lining of the container. The device comprises a product guide tube with an upper Liner connection end, a lower connection end – for connecting another container to be filled or for connecting a processing system for the product fed from the container (or the Liner) through the product guide tube and with an access socket branching off from the product guide tube, which is closable, wherein the liner connection end comprises a sealing ring arrangement for sealingly fixing the liner.

### Description of the Background Art

The term “liner” here may refer to an inner bag or sack arranged in a container or a separate inner shell for the product to be transported or transferred. This may also be a discharge end, e.g., a tubular film, which is fixed to the container to be emptied, which may have any shape.

Such devices are used in particular to transfer free-flowing bulk materials from one container to another with minimal contamination (especially for emptying big bags) or to feed such bulk materials from the container into a production process.

First, the liner itself or a connecting piece (a tubular outlet end of the liner) is fixed and sealed at the connection end of the product guide tube so that no product can escape into the environment during emptying or transfer. To change the container, a contaminated liner end can then be removed via a hose film system in a sealed bag through the sealable access socket without the product on the liner being able to escape into the environment. At the same time, such systems ensure that the product to be transferred or emptied cannot be contaminated from the outside.

Due to constantly increasing requirements for occupational safety, purity, and low emissions in transfer processes, such low-contamination systems are increasingly in demand in the industrial sector, where requirements that were previously only known in the pharmaceutical sector are becoming more and more prevalent.

Such devices are known, for example, from DE 102019110413 B3. Similar devices and methods are also known from EP 4046927 A1 and EP 1958900 B1, which corresponds to US 2008/0145198.

DE 102019109648 A1 relates to a connecting device for connecting a tubular film to a device, wherein the connecting device comprises: a base body forming a channel, wherein the channel extends along a channel axis and ends at an opening of the base body and opens to the outside; a clamping device which surrounds the opening of the base body and is designed to clamp the tubular film in a clamping space after it has been pulled over the base body in such a way that the tubular film is sealed and a powder/granulate product can be transferred between the base body and the tubular film without contamination; and an insertion means which at least partially surrounds the base body and the tubular film pulled over the base body and is movable both in a circumferential direction surrounding the channel axis and in a circumferential direction opposite to the circumferential direction, that, when moving in the circumferential direction, it is displaced radially to the channel axis into the clamping space and thereby transfers the tubular film radially constricting into the clamping space, and when moving in the opposite circumferential direction, it is displaced radially to the channel axis out of the clamping space.

In the known methods, however, the construction and handling of the liner connection can be complex and complicated. The configuration of the access socket for dust-free removal of contaminated liner ends is also capable of improvement.

### SUMMARY OF THE INVENTION

It is therefore an object of the invention to provide a device and a method for emptying a container with a liner, in which the known disadvantages can be at least partially eliminated

According to a first aspect, the present invention provides a device for emptying a container with a liner, with: a product guide tube with an upper liner connection end, a lower connection end, and a access socket branching off from the product guide tube and capable of being closed, wherein the liner connection end comprises a sealing ring arrangement for sealingly fixing the liner, which has an outer ring arrangement fixedly connected to the product guide tube and a guide ring arrangement formed coaxially to the outer ring arrangement and axially adjustable along a tube axis, wherein the outer ring arrangement has on its inner side a lower and an upper radially inwardly adjustable sealing ring which are spaced apart from one another in the axial direction along the tube axis, the guide ring arrangement comprises a guide socket with an outer sealing surface which are arranged in a working position of the guide ring arrangement radially inside the sealing rings, against which the sealing rings are attachable in their sealing position for sealing and fixing the liner, and between the product guide tube and the outer ring arrangement, there is arranged an annular receiver arrangement which has a docking socket with an outer sealing surface which is arranged and formed radially inside the lower sealing ring in such a way that the lower sealing ring is attachable against the outer sealing surface in its sealing position for sealing the liner when the guide ring arrangement is not in the working position.

According to a second aspect of the present invention, a method is provided. According to a further aspect, a method is provided in which, using the device according to the invention, the following is carried out: fixing the liner to the conical outer sealing surface of the docking socket via the lower sealing ring; closing and separating the liner end; pulling the liner into the product guide tube; pre-fixing a new liner to the guide ring arrangement; moving the guide ring arrangement from a change position to an intermediate position; release of the closed liner end; removal of the liner end through the access socket; adjusting the guide ring arrangement into the working position and sealing the new liner 50' on the outer sealing surface of the guide socket via the sealing rings; and starting the emptying and respectively the filling process.

Optionally, a step can also include a tightness test of the system. This allows safe, simple, and improved container emptying.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of an example of a device according to the invention;

FIG. 2 shows a longitudinal sectional view of the device from FIG. 1;

FIG. 2a shows an enlarged view of detail A from FIG. 2, in which the guide ring arrangement is shown in an intermediate position;

FIG. 2b shows Detail A from FIG. 2, showing the guide ring arrangement in its working position;

FIG. 3 shows the device according to the invention, in which the guide ring arrangement is shown in its change position;

FIG. 3a shows Detail B from FIG. 3, showing the outer ring arrangement without the engaging guide ring arrangement;

FIG. 4 shows a longitudinal sectional view of the access socket with the inserted plug;

FIG. 4a shows Detail C from FIG. 4; and

FIG. 5 shows a method according to the invention using a device according to the invention.

### DETAILED DESCRIPTION

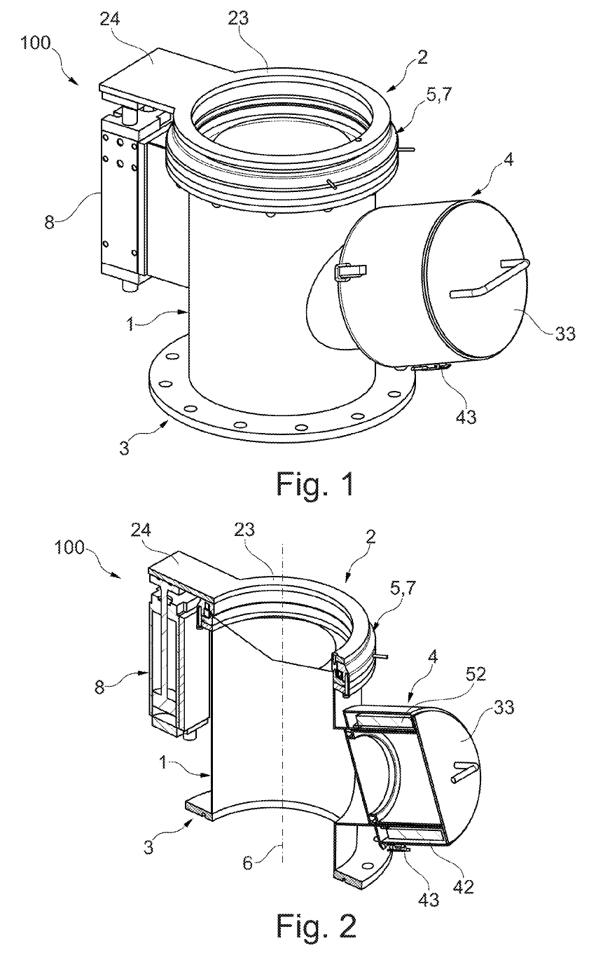

Before providing a detailed description of the example with reference to FIG. 1, general explanations of the examples will first be provided.

An example of the device is characterized, among other things, in that the outer ring arrangement has a lower and an upper sealing ring on its inner side, which are radially inwardly adjustable and spaced apart from each other in the axial direction along the tube axis. In conjunction with the guide arrangement with its guide connection with an outer sealing surface, which are arranged radially inside the sealing rings in a working position, it is ensured that the liner can be reliably sealed at any times during the filling process itself, but also during liner replacement. The combination of the guide socket on the guide ring arrangement and the docking socket on the receiver arrangement ensures particularly simple guidance of the liner hose by the sealing rings and respective outer sealing surfaces of the guide socket and the docking socket, thereby also ensuring a reliable sealing function.

A first end profile is arranged at the lower end of the guide socket, which is formed complement to a second end profile at the upper end of the docking socket.

The first and second end profiles form a guide labyrinth which ensures that the liner film passing between the sealing rings and, in particular, the outer sealing surface of the guide socket, can be sealed reliably and largely without wrinkles.

The example thus ensures that double sealing of the liner on the outer sealing surface of the guide ring arrangement can be guaranteed when it is in its working position.

A liner end to be removed can be sealed by the lower sealing ring on the outer sealing surface of the docking socket, while at the same time a new liner end can be sealed at the lower end region of the outer sealing surface of the guide ring arrangement with the upper sealing ring. This reliably seals the space for removing the used liner piece.

The configuration of the first and second end profiles allows the guide ring arrangement to move from an intermediate position to the working position, in which a new liner can be guided completely into the sealing surface areas of the outer ring arrangement and the liner is clamped without damage by the guide labyrinth formed by the two intermeshing end profiles.

The sealing rings can be made as inflatable seals that can be actuated by compressed air. This allows simple pneumatic actuation, which can be used without risk even with potentially flammable or explosive products.

The outer ring arrangement and the receiver arrangement can be coupled to one another via a flange on the product guide tube via a screw connection passing through the flange and the receiver arrangement and engaging in the outer ring arrangement. This makes it easy to produce a functional unit which reliably fixes the components to each other. The sealing grooves in a flange ring of the receiver arrangement allow chambered O-ring seals to be manufactured with little machining effort and to function reliably.

Actuating the guide ring arrangement via a linear drive allows simple, reliable, precise, and automatable actuation of the guide ring arrangement, which can thus be adjusted axially along the tube axis between a change position, an intermediate position, and a working position. If necessary, further intermediate positions can be provided and/or the adjustment speeds can be adjusted. For example, the guide ring arrangement can be moved from the change position to the intermediate position at a relatively high speed, while the adjustment from the intermediate position to the working position can be carried out at a reduced speed in order to protect the liner material.

An access socket can be provided which comprises a carrier tube which opens with its inner end into the product guide tube (1), and whose outer end can be closed with a plug which has a closing piston which fills the carrier tube and acts against the inner side of the carrier tube via a radially adjustable sealing ring at its inner end. This ensures that the product guide tube is sealed reliably during filling.

The air supply for actuating this sealing ring, which is formed as an inflatable seal, is easy to manufacture and install.

The configuration of the receiving area for the sealing ring and the configuration as a ring groove with a detachably connected flange ring are particularly easy to install and maintain.

The removable hose cassette allows modular replacement and reliable closure of the access to the extraction hose held in the hose cassette.

There are examples in which a different system for the liner connection is implemented in conjunction with the access socket described above.

The process steps allow a particularly simple and stringent operating sequence of the device according to the invention and ensure low-contamination replacement of the liner and operation of the device.

Returning to FIG. 1, this illustrates an example of the device 100 according to the invention with a product guide tube 1 extending vertically from top to bottom with an upper liner connection end 2 and a lower connection end 3, as well as a closable access socket 4 branching off from the product guide tube 1.

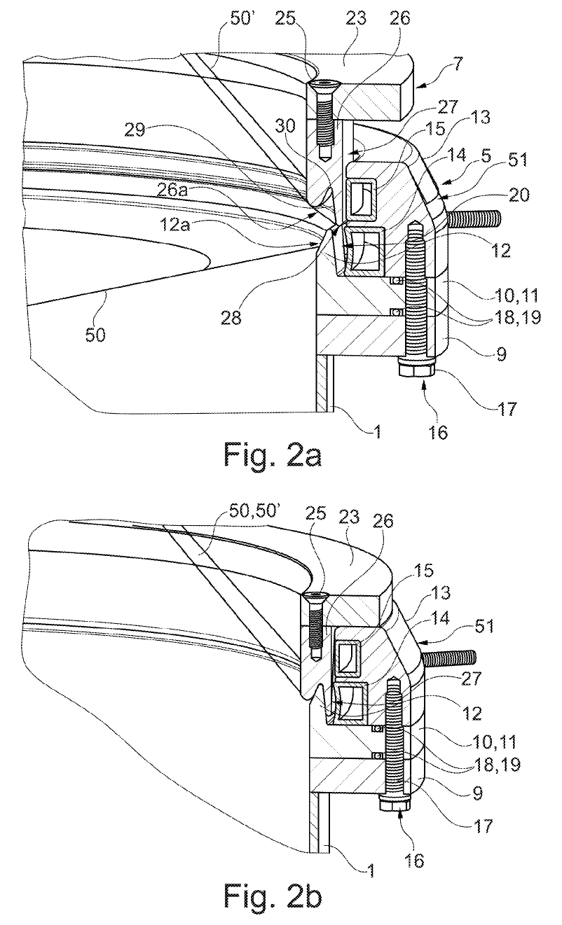

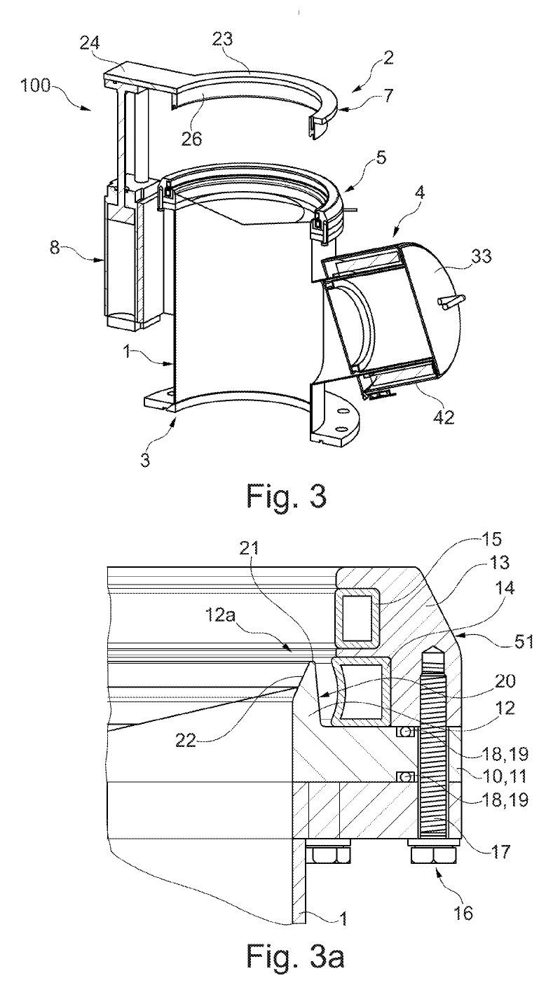

The liner connection end 2 is shown in detail in FIGS. 2a, 2b and 3a. It comprises an outer ring arrangement 5 and a guide ring arrangement 7 which is adjustable along the tube axis 6. The guide ring arrangement 7 is adjusted via of a linear drive 8 which is fastened to the product guide tube 1.

The outer ring arrangement 5 comprises a connecting flange 9 welded to the product guide tube 1, a socket ring 10 formed as a ring-shaped receiver arrangement with a flange portion 11 and a docking socket 12. The outer ring arrangement 5 further comprises a seal carrier ring 13, which has two recesses on its inner side for an upper and lower sealing ring 14, 15, which are formed as radially inwardly acting inflatable seals. The flange portion 11, the socket ring 10 and the seal carrier ring 13 can be firmly coupled to one another via a screw connection 16. In this case, fastening screws 17 pass through the connecting flange 9 and the flange portion 11 and are screwed into the seal carrier ring 13.

Ring-shaped sealing grooves 18 are provided in the upper and lower flange sides of the socket ring 10 to receive an O-ring 19, so that the socket ring 10 is sealed against the connecting flange 9 and the seal carrier ring 13.

The docking socket 12 comprises a conical outer sealing surface 20, which is arranged radially inside the lower sealing ring 14 and against which the activated – pressurized – sealing ring 14 attaches and seals the liner material located there. The conical outer sealing surface 20 merges into a likewise conical inner surface 22 via a rounded end edge 21. The conical outer sealing surface 20, the end edge 21 and the inner surface 22 form a second end profile 12a on the docking socket 12.

The guide ring arrangement 7 comprises a carrier ring 23 which is coupled to the linear drive 8 via a lug 24. The carrier ring 23 is firmly connected to an annular guide socket 26 via a screw connection 25 passing through the carrier ring 23.

The guide socket 26 comprises a cylindrical outer sealing surface 27 which, in a working position of the guide ring arrangement, extends radially inside the lower and upper sealing rings 14 and 15 (see FIG. 2b). A first end profile 26a is formed on the guide socket 26, which is formed by the outer sealing surface 27, which merges into a conical inner surface 29 via a rounded end edge 28 and into a conical outer surface via a groove base 30.

In the working position of the guide ring arrangement, the end edge 21 of the docking socket 12 (second end profile) is placed in the groove base 30 of the guide socket 26 (first end profile).

FIG. 2a shows the guide ring arrangement 7 in an intermediate position in which the outer sealing surface 27 is arranged with its lower region only in the region of the upper sealing ring 15, and FIG. 2b shows the guide ring arrangement 7 in its working position in which the outer sealing surface 27 is arranged in the region of both sealing rings 14 and 15.

FIG. 3 shows the guide ring arrangement 7 in a change position in which the guide ring arrangement 7 is arranged completely outside the outer ring arrangement 5. In this position, the linear drive is completely extended.

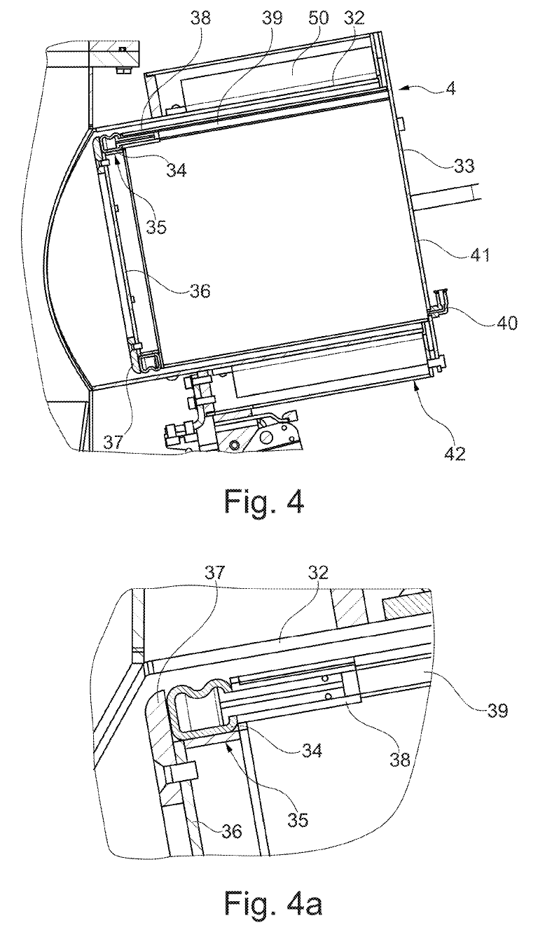

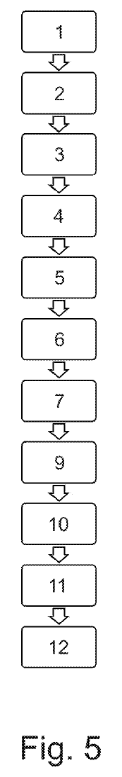

The structure of the access socket 4 shown in FIGS. 1, 2, 3, and in particular in FIGS. 4 and 4a is as follows. The access socket 4 comprises a carrier tube 32 which is welded into the product guide tube 1 as a socket extending radially upwards at an angle.

A closing piston 33 serves to close the access socket 4. At its inner end, the closing piston 33 comprises a sealing ring 34 which can be adjusted radially outwards and is also formed as an inflatable seal. The sealing ring 34 sits on a tapered end 35 of the closing piston 33 and is axially fixed there by a flange ring 37 screwed to the bottom 36.

When the sealing ring 34 is actuated, its outer sealing surface rests against the inner wall of the carrier tube 32 and seals the carrier tube to the outside. The sealing ring is actuated via an air connection running in the axial direction of the closing piston 33, which is coupled via a connector 38 fixed in the sealing ring to a line 39 with a connection end 40, which is arranged in a lid member 41 which closes the closing piston 33 at the outer end. The line 39 thus runs through the cavity of the closing piston 33 from the sealing ring 34 to the outside through the lid member 41.

A shell-shaped hose cassette 42 is arranged on the outside of the carrier tube, in which a compressed (gathered) foil hose is arranged, which can be guided from the outside to the inside into the carrier tube 32. The hose cassette is removably coupled to the carrier tube 32 via clamping closures 43.

The function and handling of the device 100 are described below.

In the initial position, the guide ring arrangement 7 is initially in its working position (see FIG. 2b). An existing liner 50 runs between the first and second end profiles 12a, 26a on the guide socket 26 and on the docking socket 12 (see FIG. 2b). It runs around the end edge 28 along the outer sealing surface 27 and between the carrier ring 23 and the seal carrier ring 13 towards the outside. The liner 50 is sealed by the two sealing rings 14 and 15 on the outer surface 27 of the guide socket 26. Both sealing rings 14 and 15 are activated, i.e. inflated.

The piece of liner protruding from the top of the liner connection end 2 is sealed tightly with a longitudinally separable plug (not shown).

The plug is cut through and the closed, docked liner end 50 closes the product guide tube 1 at the liner connection end 2.

The upper sealing ring 15 is deactivated and the guide ring arrangement 7 is moved to the change position shown in FIG. 3. At the time, the outer sealing surface 27 moves axially out of engagement with the lower sealing ring 14, which, however, continues to seal the liner material of the liner 50 (closed end) against the conical outer sealing surface 20 on the docking socket (12) (see FIG. 3a).

The guide ring arrangement 7 is in the change position. A new liner 50' is inserted from above through the opening of the guide ring arrangement 7 and is pre-fixed from the inside to the outside on the guide ring arrangement 7, thereby enclosing in particular the guide socket 26, the outer sealing surface 27 and the carrier ring 23. Alternatively, it can also be guided over the conical outer surface 51 of the seal carrier ring 13.

The guide ring arrangement 7 is moved axially into its intermediate position (see FIG. 2a). The outer sealing surface 27 then enters the area of the upper sealing ring 15 and provisionally seals the new liner 50'.

To remove the sealed end of the liner, it is sucked inwards into the product guide tube 1 so that the sealed end runs in the area of the access socket 4.

The closing piston 33 is removed and the liner can be gripped through the carrier tube 32 via a closed end of the extraction hose 52, which is guided from the hose cassette 42 into the interior of the carrier tube 32. The lower sealing ring 14 is deactivated and the liner end 50 can be pulled completely into the end of the extraction hose 52 and is removed with this from the access socket without external contact and hermetically sealed with a hose closure.

The plug of the extraction hose 52 is also split and the closed end is pushed back into the access socket 4 with the liner end without the separated bag. The closing piston 33 is inserted and the sealing ring 34 is activated so that the extraction connection or the access socket 4 is firmly closed again.

The guide ring arrangement 7 is now moved into its working position (see FIG. 2b) and the lower sealing ring 14 is activated so that the new liner 50' is now sealed by both sealing rings 14 and 15 on the outer sealing surface 27 of the guide socket 26.

The tightness of the system can now be checked via an air connection (not shown) and a suitable pressure sensor.

The newly inserted liner 50' is opened and another emptying, filling or transfer process can be carried out via the liner through the product guide tube 1, which is sealed to the outside.

In summary, the process described in detail above comprises the following steps:

Fixing the liner 50 to the conical outer sealing surface of the docking socket 12 via the lower sealing ring 14;

Sealing and separating the liner end 50;

Pulling the liner 50 into the product guide tube 1;

Pre-fixing a new liner 50' to the guide ring arrangement 7;

Moving the guide ring arrangement 7 from an change position to an intermediate position;

Releasing the sealed liner end 50;

Removal of the liner end 50 through the access socket;

Adjusting the guide ring arrangement 7 into the working position and sealing the new liner 50' on the outer sealing surface 27 of the guide socket 26 via the sealing rings 14 and 15;

Starting the emptying and respectively the filling process;

Stopping the filling process

Closing and separating the liner end (50')

Moving the empty guide ring arrangement (7) into the change position.

Optionally, step (8) may also include a tightness test of the system.

Further examples of the invention will be apparent to those skilled in the art from the claims.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for emptying a container with a liner, the device comprising:
a product guide tube;
an upper liner connection end comprising a sealing ring arrangement for sealingly fixing the liner;
a lower connection end; and
an access socket branching off from the product guide tube and being adapted to be closed,
wherein the upper liner connection end comprise an outer ring arrangement fixedly connected to the product guide tube and a guide ring arrangement formed coaxially to the outer ring arrangement and axially adjustable along a tube axis,
wherein the outer ring arrangement has on its inner side a lower and an upper radially inwardly adjustable sealing ring which are spaced apart from one another in the axial direction along the tube axis,
wherein the guide ring arrangement comprises a guide socket with an outer sealing surface which are arranged in a working position of the guide ring arrangement radially inside the sealing rings against which the sealing rings are attachable in their sealing position for sealing and fixing the liner, and
wherein, between the product guide tube and the outer ring arrangement there is arranged an annular receiver arrangement which has a docking socket with an outer sealing surface which is arranged and formed radially inside the lower sealing ring in such a way that the lower sealing ring is attachable against the outer sealing surface in its sealing position for sealing the liner when the guide ring arrangement is not in the working position.

2. The device according to claim 1, wherein the guide socket has at its lower end a first end profile which is complementary to a second end profile at the upper end of the docking socket.

3. The device according to claim 2, wherein in the working position of the guide ring arrangement its outer sealing surface is arranged radially inward and opposite the sealing rings, the first and second end profiles engage with one another and a lower end portion of the outer sealing surface of the guide ring arrangement covers the outer sealing surface of the docking socket.

4. The device according to claim 1, wherein in an intermediate position of the guide ring arrangement a lower end portion of the outer sealing surface is arranged radially inward and opposite the upper sealing ring and the outer sealing surface of the docking socket is free, so that the upper sealing ring is attachable on the lower end portion of the outer sealing surface of the guide ring arrangement and the lower sealing ring is attachable on the outer sealing surface of the docking socket.

5. The device according to claim 1, wherein the outer sealing surface of the docking socket is conical and merges via a rounded end edge into a conical inner surface and thus forms the second end profile, wherein the outer sealing surface of the guide ring arrangement is cylindrical and merges via a rounded end edge into a conical inner surface, which merges via a rounded groove base into a conical outer surface and thus forms the first end profile, and wherein the first and second end profiles are configured and arranged such that they engage with one another in the working position of the guide ring arrangement.

6. The device according to claim 1, wherein the sealing rings are made as inflatable seals actuatable by compressed air.

7. The device according to claim 1, wherein the outer ring arrangement and the receiver arrangement are coupled to one another via a connecting flange on the product guide tube via a screw connection passing through the connecting flange and the receiver arrangement and engages in the outer ring arrangement, and wherein an annular sealing groove is formed on the receiver arrangement on the flange side and on the outer ring side.

8. The device according to claim 1, wherein the guide ring arrangement is axially adjustable via a linear drive between a change position, an intermediate position and a working position.

9. The device according to claim 1, wherein the access socket comprises a carrier tube which opens with its inner end into the product guide tube, and wherein the outer end is closable with a plug which has a closing piston filling the carrier tube and which has at its inner end a radially adjustable sealing ring which, in its sealing position, acts against the inside of the carrier tube.

10. The device according to claim 9, wherein the sealing ring is configured as an inflatable inflating tube which is actuatable via an air connection running in the axial direction of the closing piston, which is connected via an access running inside the closing piston to an air connection arranged at the outer end of the closing piston.

11. The device according to claim 9, wherein the sealing ring is arranged in an annular groove at the inner end of the closing piston, which is formed by a tapered end of the closing piston and a flange ring detachably connected to the bottom of the closing piston.

12. The device according to claim 8, wherein the access socket is surrounded by a shell-shaped, removable hose cassette surrounding it, the outer end of which can be closed with a lid member of the plug.

13. A method for emptying a container with a liner using the device according to claim 1, the method comprising:
fixing the liner to the conical outer sealing surface of the docking socket via the lower sealing ring;
closing and separating the liner end;
pulling the liner into the product guide tube;
pre-fixing a new liner to the guide ring arrangement;
moving the guide ring arrangement from a change position to an intermediate position;
releasing the closed liner end;
removing the liner end through the access socket;
adjusting the guide ring arrangement into the working position and sealing the new liner on the outer sealing surface of the guide socket via the sealing rings;
starting the emptying and respectively the filling process;
stopping the filling process;
closing and separating the liner end; and
moving the empty guide ring arrangement into the change position.

14. The method according to claim 13, further comprising: perform a tightness test of the system after adjusting the guide ring arrangement into the working position and sealing the new liner on the outer sealing surface of the guide socket via the sealing rings.
